(19) United States
(12) Patent Application Publication
(10) Pub. No.: US 2012/0218556 A1
(43) Pub. Date: Aug. 30, 2012

(54) OPTICAL CANTILEVER BASED ANALYTE DETECTION

(75) Inventors: John Marcel Dell, Bull Creek (AU); Mariusz Martyniuk, Wattle Grove (AU); Adrian John Keating, Mt. Hawthorn (AU); Gino Michael Putrino, Dianella (AU); Lorenzo Faraone, Mt. Lawley (AU)

(73) Assignee: University of Western Australia, Perth (AU)

(21) Appl. No.: 13/035,181

(22) Filed: Feb. 25, 2011

(51) Int. Cl. G01B 9/02

(52) U.S. Cl. 356/478

(57) ABSTRACT

An apparatus for detecting a presence of one or more analytes in a sample. A plurality of optical cantilevered waveguides (200a, 200b) are optically coupled to an optical circuit between an input and an output of the circuit. Each of the optical cantilevered waveguides (200a, 200b) have an analyte selective coating, at least two of the waveguides having different analyte selective coatings. A detection module (304) analyses the output of the circuit to detect the presence of analytes in the sample.

### FIELD OF THE INVENTION

The present invention relates to an apparatus and method for detecting analytes, and more particularly to detecting analytes in a sample using optical cantilevers.

### BACKGROUND OF THE INVENTION

Different methods for detecting chemical and biological analytes have been used. Such technology has been used, for example, in process control, environmental monitoring, medical diagnostics and security.

Mass spectroscopy is one approach to detect such analytes. The process begins with an ionized sample. The ionized sample is shot through a vacuum that is subjected to an electromagnetic field. The electromagnetic field changes the path of lighter ions more than heavier ions. A series of detectors or a photographic plate are then used to sort the ions depending on their mass. The output of this process, which is the signal from the detectors or the photographic plate, can be used to determine the composition of the analytes in the sample.

A disadvantage of mass spectroscopy instruments is that they are generally high-cost instruments. Additionally, they are difficult to ruggedize, and are not useful for applications that require a sensor head to be remote from signal-processing electronics.

A more recent approach is to use Micro Electro Mechanical Systems (MEMS)-based microstructures, and more specifically micro-cantilevers. These are extremely sensitive systems, and several demonstrations of mass sensors that have detection limits as low 10⁻²¹ g, approximately the mass of a single protein molecule, have been performed. While these experiments have been performed in idealised environments, practical cantilever-based systems have been demonstrated for the detection of a wide range of single analytes.

Typically, a portion of the micro-cantilever is coated with an analyte selective coating to which the analyte is adsorbed.

There are two common modes of operation of micro-cantilever sensors, namely static and dynamic.

In static sensors, a stress differential is induced across the cantilever due to preferential adsorption of an analyte onto the analyte selective coating causing the cantilever to bend. The extent of the bending is in direct relation to the amount of analyte adsorbed. The stress differential can be induced by the analyte causing swelling of an overlayer, or by changes in the Gibbs free energy of the surface.

In dynamic sensors, the adsorbed analyte changes the mass of the cantilever and hence its mechanical resonance frequency. The rate and size of the change in resonance frequency is then measured to estimate the analyte concentration. Active sensing using these structures is achieved by resonant excitation.

In general, long, compliant cantilevers are required for sensitive static sensors, while high sensitivity for dynamic sensors dictate that short, stiff cantilevers with high Q-factor mechanical resonances are needed. The most sensitive MEMS-based sensors to date have been based on measurements of resonance frequency.

Readout technologies used with micro-cantilever sensors are primarily based on optical techniques developed for atomic force microscopy (AFM) analysis. Here, light is reflected from the cantilever tip to a distant quadrant detector, which process is referred to as optical leveraging. Electrical sensing and optical sensing techniques are also used. Electrical sensing includes piezoresistive, piezoelectric, capacitive, Lorentz force/emf sensing and tunnelling current techniques. Optical sensing techniques include optical sensing based on optical interference, the optical interference being either in an interferometer or in the use of diffraction from an optical grating formed by a line of cantilevers. This latter configuration using an optical grating formed by a line of cantilevers is often described as an array in literature, but is still effectively a sensor for a single analyte.

Another approach to analyte detection is where large, compact, integrated arrays of individual sensors are used, particularly for multi-analyte, multi-analysis applications. These are particularly useful when an unknown substance is to be identified or if there is a number of chemical species to be tested for simultaneously. Examples of such requirements can be found in the screening of food for pesticide residues where there are many different potential contaminants, detection of different antibodies in a single blood sample, or the presence of any of the many possible illicit drugs or explosives in luggage. Additionally, an array of sensors can also give significantly improved statistics of detection (including fewer false-positives and false-negatives) by averaging the response over a large number of sensors, and allows the use of multivariate statistical chemometric techniques, as are typically applied in spectroscopic analysis.

There are several disadvantages with current analyte detection techniques. Firstly, there is currently no known method to cost-effectively integrate a large number of sensors onto a single substrate. Additionally, there is a lack of a compact, robust and cost-effective read-out technology that combines high sensitivity with high dynamic range.

A limitation to the application of cantilever sensors to sensor arrays results from the technologies currently available to measure the changes in the cantilever induced by the analyte. A problem with AFM-based cantilever systems in sensor arrays is that they are very large as they incorporate bulky free space optics. Furthermore, a problem with electrical cantilever systems is that they require extensive power on-chip electronics.

The present invention is aimed at one or more of the problems set forth above.

### SUMMARY OF THE INVENTION

Example methods and cantilever systems are described.

In one example embodiment, the invention resides in an apparatus for detecting a presence of one or more analytes in a sample, said apparatus comprising an optical circuit comprising an input and an output, a plurality of optical cantilevered waveguides optically coupled to the optical circuit between the input and the output, wherein each waveguide in the plurality of optical cantilevered waveguides has an analyte selective coating, and a detection module, connected to the output, that analyses the output for detection of the presence of one or more analytes in said sample, wherein at least two of the plurality of optical cantilevered waveguides have different analyte selective coatings.

In one embodiment of the present invention, a first optical cantilevered waveguide and a second optical cantilevered waveguide are optically coupled in series.

In a second embodiment of the present invention, a first optical cantilevered waveguide and a second optical cantilevered waveguide are optically coupled in parallel.

In one aspect, the first optical cantilevered waveguide and the second optical cantilevered waveguide may have different analyte selective coatings and different mechanical resonance frequencies.

In one embodiment, the apparatus further comprises a wavelength division de-multiplexer wherein an optical source is split into a plurality of optical signals using wavelength division de-multiplexing, a first optical signal sent to the first optical cantilevered waveguide and a second optical signal sent to the second optical cantilevered waveguide.

The detection module may comprise a frequency domain de-multiplexer, wherein light modulated by the first optical cantilevered waveguide and the second optical cantilevered waveguide is analysed using a mechanical resonance frequency of the first optical cantilevered waveguide and the second optical cantilevered waveguide and frequency domain de-multiplexing.

In one embodiment, the detection module identifies the first optical cantilevered waveguide and the second optical cantilevered waveguide through wavelength analysis.

In an other embodiment, the detection module identifies the first optical cantilevered waveguide and the second optical cantilevered waveguide through frequency domain analysis.

In one aspect of the present invention, the detection module may compare light modulated by the optical cantilevered waveguides with a plurality of predefined signals representing light modulated by said plurality of optical cantilevered waveguides in the presence of one or more analytes.

The optical cantilevered waveguides may be dynamic optical cantilevered waveguides.

In an alternative embodiment, the invention resides in a method of detecting the presence of one or more analytes in a sample, the method comprising the steps of:

applying the sample to a plurality of optical cantilevered waveguides wherein one or more of the plurality of cantilevered waveguides is configured to react to one or more analytes;

passing a single optical signal through an optical circuit optically coupled to the plurality of cantilevered waveguides comprising at least two different analyte selective coatings; and

analysing the optical signal of said plurality of cantilevered waveguides after it passes through said optical circuit.

The method may further comprise the steps of:

splitting the optical signal into a plurality of subsignals using wavelength division multiplexing, each subsignal being associated with a particular wavelength;

sending a first subsignal of the plurality of subsignals to a first optical cantilevered waveguide of said plurality of optical cantilevered waveguides; and

sending a second subsignal of said plurality of subsignals to a second optical cantilevered waveguide of said plurality of optical cantilevered waveguides

In one embodiment, a first optical cantilevered waveguide and a second optical cantilevered waveguide are optically coupled in series, the first optical cantilevered waveguide and the second optical cantilevered waveguide have different mechanical resonance frequencies; and the step of analysing the optical signal comprises frequency domain de-multiplexing.

The step of analysing the optical signal may further comprise the step of comparing the optical signal with a plurality of predefined signals, each predefined signal representing the presence of one or more analytes.

In one embodiment, two of more of the cantilevered waveguides are configured to redundantly detect the presence of the same analyte.

In one embodiment, the step of analysing the optical signal is performed at a different time than the step of applying the sample.

In one embodiment, the step of analysing the optical signal may be performed by comparing a resonance frequency of a cantilevered waveguide of the plurality of cantilevered waveguides with a second predefined resonance frequency of the cantilevered waveguide upon the presence of a known amount of analyte.

In one embodiment, the step of analysing the optical signal may be performed by estimating a deflection of a cantilevered waveguide and by comparing the deflection with a second predefined deflection of the cantilevered waveguide upon the presence of a known amount of analyte.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 shows a side sectional view of an optical cantilevered waveguide, according to the prior art;

FIG. 2 shows two optical cantilevered waveguides optically coupled in series, according to an embodiment of the present invention;

FIG. 3 shows a block diagram of a sequence of optical cantilevered waveguides coupled to a single optical source, according to an embodiment of the present invention;

FIG. 4 shows a block diagram, according to a further embodiment of the present invention, of two optical cantilevered waveguides optically coupled in a parallel arrangement and with a single optical source;

FIG. 5 shows a block diagram of a plurality of optical cantilevered waveguides optically coupled to a sensor chip, according to an embodiment of the present invention; and

FIG. 6 is a graph showing a modelling of the effect of displacement of the tip of the dynamic component of the optical cantilevered waveguide, on the amplitude of light entering the fixed waveguide, for a single moded (in the vertical direction) optical cantilevered waveguide according to an embodiment of the invention.

### DETAILED DESCRIPTION

While the present invention is open to various modifications and alternative constructions, the example embodiments shown in the drawings will be described herein in detail. It is to be understood, however, there is no intention to limit the invention to the particular example forms disclosed. On the contrary, it is intended that the invention cover all modifications, equivalences and alternative constructions falling within the spirit and scope of the invention as expressed in the appended claims.

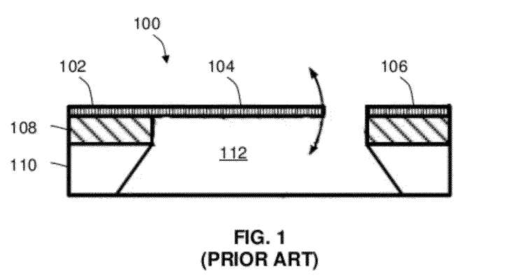

FIG. 1 shows a side sectional view of an optical cantilevered waveguide 100, according to the prior art. The optical cantilevered waveguide 100 comprises a fixed component 102 and a dynamic component 104. The fixed component is attached to an insulator 108 such as for example SiO₂ or Si3N₄. The insulator 108 is attached to a substrate 110 such as for example a Si substrate. This layered structure allows for the simple construction of the optical cantilevered waveguide 100 through layering of the substrate 110, the insulator 108 and the optical cantilevered waveguide 100, and by then etching away an area of the insulator 108 (and possibly also an area of the substrate 110) forming a void 112 under the dynamic component 104 of the optical cantilevered waveguide 100. The dynamic component 104 of the cantilevered waveguide 100 is optically coupled to a fixed waveguide 106.

The dynamic component 104 is free to move above the void 112 in the insulator 108. Upon adsorbtion of an analyte, the mass of the dynamic component 104 of the optical cantilevered waveguide 100 changes. This change in mass results in a change of a resonance frequency of the optical cantilevered waveguide 100.

Light enters at an end of the fixed component 102 of the optical cantilevered waveguide 100 and propagates along the waveguide 100 to the dynamic component 104. Light exits the dynamic component 104 in a direction towards the fixed waveguide 106.

The light entering the fixed waveguide 106 is amplitude modulated as a result of a coupling loss between the dynamic component 104 and the fixed waveguide 106 that is in close proximity to the dynamic component 104, which loss occurs as the dynamic component 104 vibrates. The light entering the fixed waveguide 106 is nominally modulated at twice the vibration frequency of the dynamic component 104 for symmetric vibration. Alternatively, the dynamic component 104 of the optical cantilevered waveguide 100 may change shape upon adsorbtion of an analyte. In this case the light entering the fixed waveguide 106 has an amplitude based upon the shape of the dynamic component 104 of the optical cantilevered waveguide 100.

The light source entering the fixed waveguide 106 is analysed to detect the presence of an analyte. The light source may be compared to light sources with well known characteristics, such as for example light modulated due to the presence of an analyte. Alternatively, the resonance frequency or shape of the optical cantilevered waveguide 100 may be estimated and compared to pre-determined characteristics.

The present invention resides in an apparatus for detecting a presence of one or more analytes in a sample. The apparatus comprises an optical circuit comprising an input and an output, a plurality of optical cantilevered waveguides and a detection module. The plurality of optical cantilevered waveguides are optically coupled to the optical circuit between the input and the output. The detection module is connected to the output, and analyses the output for detection of the presence of one or more analytes in the sample. Each waveguide in the plurality of optical cantilevered waveguides has an analyte selective coating; and at least two of the plurality of optical cantilevered waveguides have different analyte selective coatings.

An advantage of the present invention is the ability to economically have a very large number of sensors on a small surface, enabling efficient detection of multiple analytes. Furthermore, sensors of the present invention are rugged and do not have bulky optics, and it is possible to have a separate signal processing unit.

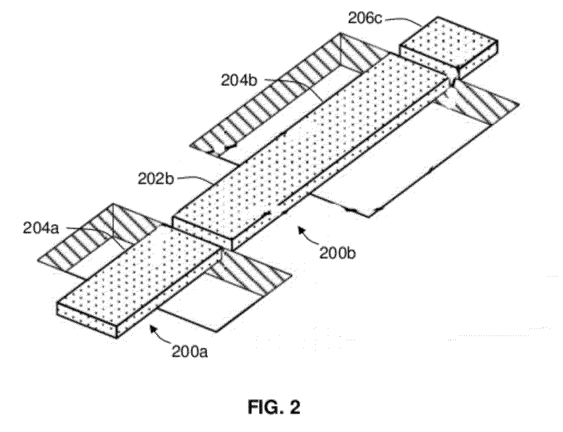

FIG. 2 shows a perspective view of first and second optical cantilevered waveguides 200a, 200b, respectively, optically coupled in series, according to an embodiment of the present invention. The first optical cantilevered waveguide 200a is optically coupled to the second optical cantilevered waveguide 200b. A dynamic component 204a of the first optical cantilevered waveguide 200a has an analyte selective coating that is selective for a first analyte.

The dynamic component 204a of the first optical cantilevered waveguide 200a is placed closely to a static component 202b of the second optical cantilevered waveguide 200b. Light enters at an end of the first optical cantilevered waveguide 200a and propagates along the waveguide to the dynamic component 204a. Light exits the dynamic component 204a in a direction towards the static component 202b of the second optical cantilevered waveguide 200b. The light entering the second optical cantilevered waveguide 200b is modulated such that the modulation corresponds to the vibration of the dynamic component 204a of the first cantilevered waveguide 200a.

The dynamic component 204b of the second optical cantilevered waveguide 200b is placed in optical communication with a static waveguide 206c. The dynamic component 204b of the second optical cantilevered waveguide 200b has an analyte selective coating that is selective for a second analyte. The light continues to propagate along the second optical cantilevered waveguide 200b to the dynamic component 204b. Light exits the dynamic component 204b in a direction towards the static waveguide 206c. The light entering the static waveguide 206c is modulated corresponding to the vibration of the dynamic components 204a, 204b of the first and second cantilevered waveguides 200a, 200b.

The dynamic components 204a, 204b of the first and second optical cantilevered waveguides 200a, 200b have different masses resulting in different resonance frequencies, and hence different modulations. As would be readily understood by a person skilled in the art, any number of optical cantilevered waveguides 200 may be optically coupled in series.

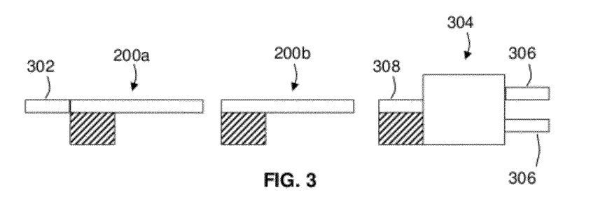

FIG. 3 shows a side view of a sequence of optical cantilevered waveguides 200a, 200b coupled to a single optical source 302, according to an embodiment of the present invention. The optical source 302, such as an optical fibre, is optically coupled to a first optical cantilevered waveguide 200a. The optical source 302 and the first optical cantilevered waveguide 200a are shown physically connected. It should however be appreciated, as is understood by a person skilled in the art, that this and any other optical coupling need not necessarily comprise a physical connection.

The first optical cantilevered waveguide 200a is optically coupled to the second optical cantilevered waveguide 200b. The first and second cantilevered waveguides 200a, 200b have different mechanical resonance frequencies. The second cantilevered waveguide 200b is optically coupled to a frequency domain de-multiplexer 304 via an input 308. The frequency domain de-multiplexer 304 splits the light entering the input 308 into a plurality of optical signals, each optical signal corresponding to an individual optical cantilevered waveguide 200.

The frequency domain de-multiplexer 304 de-multiplexes the light in the frequency domain. The mechanical resonance frequency of each optical cantilevered waveguide 200 is known, and is compared to the frequency response. In an alternative embodiment, the frequency domain calculations may be estimated. In another alternative embodiment, the light entering the frequency domain de-multiplexer 304 is compared to light with well known characteristics, such as light modulated by cantilevers in the presence of analyte.

The frequency domain de-multiplexer 304 comprises an input 308 and a plurality of outputs 306, one output 306 for each optical cantilevered waveguide 200a, 200b or analyte that is capable of being identified. In an embodiment of the invention, the light on each of the plurality of outputs 306 corresponds to modulation of the optical cantilevered waveguide 200a or 200b to which the output 306 corresponds.

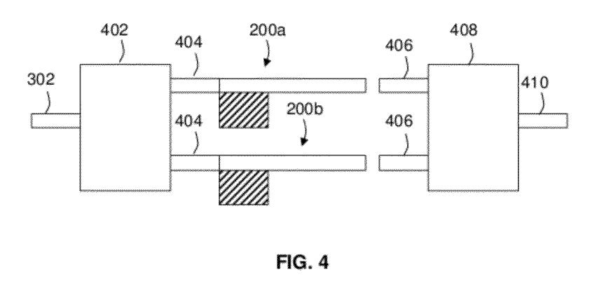

FIG. 4 shows a side view, according to a further embodiment of the present invention, of two optical cantilevered waveguides 200a, 200b, optically coupled in a parallel arrangement and with a single optical source 302. The optical source 302 is optically coupled to a wavelength division de-multiplexer 402. The wavelength division de-multiplexer 402 processes light from the optical source 302 and splits the light into a plurality of subsignals, each subsignal having a particular wavelength or plurality of wavelengths. In this example, the wavelength division de-multiplexer 402 has two optical outputs 404, each carrying light corresponding to a different wavelength or wavelength band. Each optical output 404a, 404b is optically coupled to an optical cantilevered waveguide 200a, 200b. The light continues to propagate along the optical cantilevered waveguides 200a, 200b. Each optical cantilevered waveguide 200a, 200b is optically coupled to an optical input 406 of a wavelength division multiplexer 408, to which the light propagates. The wavelength division multiplexer 408 additively combines the light on the optical inputs 406 such that the output signal comprises a single light signal comprising multiple wavelengths. The light then propagates along the optical output 410 of the wavelength division multiplexer 408.

As is understood by a person skilled in the art, the wavelength division de-multiplexer 402 need not separate all wavelengths at a single step. Specific wavelengths may be de-multiplexed from a light source as they are input to a respective optical cantilevered waveguide 200a, 200b rather than at a single time by a single unit.

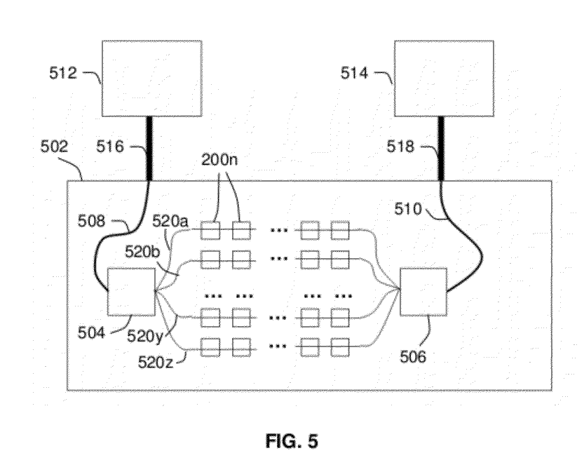

FIG. 5 shows a block diagram of a plurality of optical cantilevered waveguides 200n (similar to the waveguides 200a, 200b) optically coupled to a sensor chip 502, according to an embodiment of the present invention. The optical cantilevered waveguides 200n are optically coupled in a series and a parallel configuration. Each optical cantilevered waveguide 200n in a particular series configuration has a different resonance frequency to the other optical cantilevered waveguides 200n in the same series. The sensor chip 502 may be made from a single substrate and additionally comprises a wavelength splitter 504 and a wavelength combiner 506. The wavelength splitter 504 is optically coupled to an optical input 508, and the wavelength combiner 506 is optically coupled to an optical output 510. The optical input 508 is optically coupled to an optical source 512, which provides light of different wavelengths, via an input optical fibre 516. The optical output 510 is optically coupled to a detection module 514 via an output optical fibre 518. The wavelength splitter 504 takes the light from the optical input 508 and splits it into different wavelengths, a different wavelength being sent to each of the optical waveguides 520n (i.e., 520a to 520z). The wavelength combiner performs the reverse operation, combining the light of different wavelengths to a single, multi-wavelength light source.

The detection module 514 analyses the light on the output optical fibre 518 to detect the presence of one or more analytes in the sample. The light propagating through the different optical waveguides 520a, 520b, 520y and 520z have different wavelengths making it possible for the detection system 514 to differentiate between different groups of optical cantilevered waveguides 200n. Additionally, the detection module 514 may use the fact that each optical cantilevered waveguide 200n in a series has a different resonance frequency by using frequency domain analysis.

As will be readily understood by one skilled in the art, the abovementioned figures are illustrative of the nature of the connections of multiple optical cantilevered waveguides 200n. Many such optical cantilevered waveguides 200n may be optically coupled in a series, parallel or combination of serial and parallel arrangement, with a single light source. The parallel connection of optical cantilevered waveguides 200n is substantially lossless by using a wavelength division multiplexing approach to split the incoming light into parallel paths, each associated with a particular wavelength. Identification of individual cantilevers in a serial connection is achieved by designing each cantilever to have a different mechanical resonance frequency and by de-multiplexing the light in the frequency domain.

The terms ‘series’ and ‘parallel’ are used in this specification. Series refers to the case where an output of a first cantilever is optically connected to an input of a second cantilever. Parallel refers to the case where an input is shared between a first and second cantilever. Parallel connections include the case where the first cantilever uses or modifies a first part of the input, and the second cantilever uses or modifies a second part of the input, even where a series physical connection exists.

Identification of the individual cantilevers, or identification of individual analytes in a sample, may be performed a single time, as a final step, or in multiple instances in the system. Additionally, the detection module need not be directly connected to the apparatus. The signal can, for example, be recorded and analysed at a different time than the application of the sample.

Additionally, the direction of travel of the light through different components of the system is for illustrative purposes. As is understood by a person skilled in the art, light can travel in either direction through a component. For example, light may enter the dynamic component 202 of an optical cantilever waveguide 200 and exit through the static component 204.

Similarly, the terms light, optical source and optical signal are used throughout this specification. As is understood by a person skilled in the art, a light or optical signal may be converted back and forth to a signal of another type, for example an electronic signal. When light, optical source, optical signal are used, the light signal may actually be sent and/or processed in a non-optical form such as an electrical signal. An example of this is the detection module 514 which may receive an electronic version of the optical signal.

In an alternative embodiment of the invention, not all optical cantilevered waveguides 200n have different wavelength light input or different resonance frequencies. It may be desirable to have multiple optical cantilevered waveguides 200n configured to redundantly detect the presence of the same analyte to improve the reliability of results, or for other purposes.

To allow for more than a limited number of optical cantilevered waveguides 200n to be optically coupled in series, while still being able to detect the presence of analyte on the sensors individually, the movement of the dynamic component 204 of the optical cantilevered waveguides 200n needs to be limited. Otherwise, the loss at each optical coupling could become too large. In this case it is advantageous to use detection schemes that measure changes in resonance frequency rather than static deflection. Since resonance frequency detection schemes require short, stiff cantilevers to maintain high Q-factors, they will not deflect to such an extent that insufficient light will couple to subsequent optical cantilevered waveguides 200n. In other scenarios, for example when one wishes to detect the presence of an analyte on one or more optical cantilevered waveguides 200n, but without needing to know exactly which optical cantilevered waveguide 200n, static deflection may be advantageous.

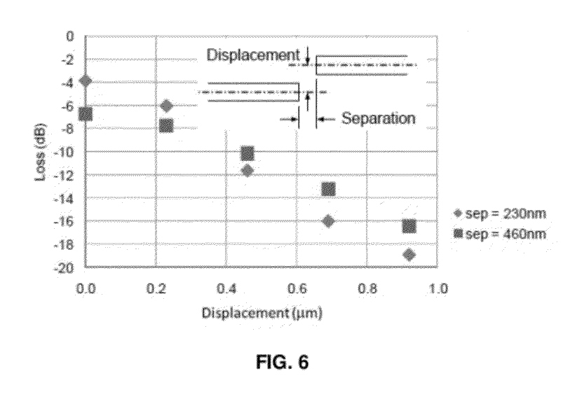

FIG. 6 is a graph showing a modelling of the effect of displacement of the tip of the dynamic component 204 of an optical cantilevered waveguide 200n, on the amplitude of light entering the fixed waveguide 206, for a single moded (in the vertical direction) optical cantilevered waveguide 200n, according to an embodiment of the invention. The modelling is calculated using a finite difference time domain model. The modelling shows that for spacing comparable to the thickness of the dynamic component 204 of the optical cantilevered waveguide 200n, the loss, i.e. the reduction in amplitude, is a sensitive function of the displacement. The graph also shows that the loss rapidly increases as the displacement increases. This is due to the fact that silicon is used in the optical cantilevered waveguide 200n and that results in a very small mode size and hence large diffraction effects. The graph also shows that the slope of the loss characteristic can be controlled by controlling the separation of the cantilevered guide from the fixed guide.

As will be understood by those having ordinary skill in the art, in light of the present description, an advantage of the present invention is the ability to economically have a very large amount of sensors on a small surface, enabling efficient detection of multiple analytes. Furthermore, sensors of the present invention are rugged, do not have bulky optics, and it is possible to have a separate signal processing unit.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

Limitations in the patent claims should be interpreted broadly based on the language used in the claims, and such limitations should not be limited to specific examples described herein. In this specification, the terminology “present invention” is used as a reference to one or more aspects within the present disclosure. The terminology “present invention” should not be improperly interpreted as an identification of critical elements, should not be improperly interpreted as applying to all aspects and embodiments, and should not be improperly interpreted as limiting the scope of any patent claims.

What is claimed is:

1. An apparatus for detecting a presence of one or more analytes in a sample, said apparatus comprising:
an optical circuit comprising an input and an output;
a plurality of optical cantilevered waveguides optically coupled to said optical circuit between said input and said output, wherein each waveguide in said plurality of optical cantilevered waveguides has an analyte selective coating; and
a detection module, connected to said output, that analyses said output for detection of said presence of one or more analytes in said sample;
wherein at least two of said plurality of optical cantilevered waveguides have different analyte selective coatings.

2. The apparatus of claim 1 wherein a first optical cantilevered waveguide of said plurality of optical cantilevered waveguides and a second optical cantilevered waveguide of said plurality of optical cantilevered waveguides are optically coupled in series.

3. The apparatus of claim 1 wherein a first optical cantilevered waveguide of said plurality of optical cantilevered waveguides and a second optical cantilevered waveguide of said plurality of optical cantilevered waveguides are optically coupled in parallel.

4. The apparatus of claim 2 wherein said first optical cantilevered waveguide and said second optical cantilevered waveguide have different analyte selective coatings and different mechanical resonance frequencies.

5. The apparatus of claim 3 further comprising:
a wavelength division de-multiplexer comprising an optical input and a plurality of optical outputs, wherein an optical source on said optical input is split into a plurality of optical signals using wavelength division de-multiplexing, a first of said optical signals sent to said first optical cantilevered waveguide via a first optical output of said plurality of optical outputs and a second of said optical signals sent to said second optical cantilevered waveguide via a second optical output of said plurality of optical outputs.

6. The apparatus in claim 4, wherein said detection module comprises a frequency domain de-multiplexer, wherein light modulated by said first optical cantilevered waveguide and said second optical cantilevered waveguide is analysed using a mechanical resonance frequency of said first optical cantilevered waveguide and said second optical cantilevered waveguide and frequency domain de-multiplexing.

7. The apparatus in claim 3, wherein said detection module identifies said first optical cantilevered waveguide and said second optical cantilevered waveguide through wavelength analysis.

8. The apparatus in claim 2, wherein said detection module identifies said first optical cantilevered waveguide and said second optical cantilevered waveguide through frequency domain analysis.

9. The apparatus in claim 1, wherein said detection module compares light modulated by said plurality of optical cantilevered waveguides with a plurality of predefined signals representing light modulated by said plurality of optical cantilevered waveguides in the presence of one or more analytes.

10. The apparatus in claim 1, wherein said optical cantilevered waveguides are dynamic optical cantilevered waveguides.

11. A method of detecting the presence of one or more analytes in a sample, said method comprising the steps of:
applying said sample to a plurality of optical cantilevered waveguides wherein one or more of said plurality of cantilevered waveguides is configured to react to one or more analytes;
passing an optical signal through an optical circuit optically coupled to said plurality of cantilevered waveguides comprising at least two different analyte selective coatings; and
analysing said optical signal after it passes through said optical circuit.

12. The method in claim 11 further comprising the steps of:
splitting said optical signal into a plurality of subsignals using wavelength division multiplexing, each said subsignal being associated with a particular wavelength;
sending a first subsignal of said plurality of subsignals to a first optical cantilevered waveguide of said plurality of optical cantilevered waveguides; and
sending a second subsignal of said plurality of subsignals to a second optical cantilevered waveguide of said plurality of optical cantilevered waveguides.

13. The method in claim 11 wherein:
a first optical cantilevered waveguide of said plurality of optical cantilevered waveguides and a second optical cantilevered waveguide of said plurality of optical cantilevered waveguides are optically coupled in series;
said first optical cantilevered waveguide and said second optical cantilevered waveguide have different mechanical resonance frequencies; and
said step of analysing said optical signal comprises frequency domain de-multiplexing.

14. The method in claim 11 where said step of analysing said optical signal comprises comparing said optical signal with a plurality of predefined signals, each said predefined signal representing the presence of one or more analytes of the plurality of analytes.

15. The method in claim 11 wherein two of more of said plurality of cantilevered waveguides are configured to redundantly detect the presence of the same analyte.

16. The method in claim 11 wherein said step of analysing said optical signal is performed at a different time than said step of applying the sample.

17. The method in claim 11 wherein said step of analysing said optical signal is performed by comparing a resonance frequency of a cantilevered waveguide of the plurality of cantilevered waveguides with a second predefined resonance frequency of said cantilevered waveguide upon the presence of a known amount of analyte.

18. The method in claim 11 wherein said step of analysing said optical signal is performed by estimating a deflection of a cantilevered waveguide of said plurality of cantilevered waveguides and by comparing said deflection with a second predefined deflection of said cantilevered waveguide upon the presence of a known amount of analyte.
